(19) United States
(12) Patent Application Publication
(10) Pub. No.: US 2024/0199380 A1
(43) Pub. Date: Jun. 20, 2024

(54) ELEVATOR SYSTEM

(71) Applicant: Inventio AG, Hergiswil (CH)

(72) Inventor: Valerio Villa, Colverde (IT)

(21) Appl. No.: 18/556,686

(22) PCT Filed: Apr. 20, 2022
(86) PCT No.: PCT/EP2022/060351

§ 371 Date: Oct. 23, 2023

(30) Foreign Application Priority Data
Apr. 30, 2021 (EP) 21171578.4

(51) Int. Cl. B66B 13/12; B66B 13/14; B66B 13/16

(52) U.S. Cl. CPC B66B 13/125; B66B 13/143; B66B 13/165

(57) ABSTRACT

An elevator system includes an elevator car that is movable in an elevator shaft. The elevator car has a car door, a car door drive for closing and/or opening the car door, and a car door control unit directly controlling the car door drive. A shaft door is provided on each door opening of the elevator shaft. Each shaft door has a shaft door drive for closing and/or opening the shaft door and a shaft door control unit directly controlling the shaft door drive. The car door control unit and the shaft door control unit are connected, preferably wirelessly, via a communication connection to open and/or close the shaft door and the car door synchronously.

### FIELD

The invention relates to an elevator system with a shaft door and a shaft door drive and a car door and a car door drive.

### BACKGROUND

Elevator systems usually comprise an elevator car which can travel in an elevator shaft and which has a car door. A car door drive is arranged on the car and is provided for opening and closing the car door. Moreover, the elevator shaft has multiple door openings arranged one above the other, with a shaft door arranged at each opening. If the car stops at one of these shaft doors and/or is positioned there, the car door is usually mechanically coupled to the shaft door by means of a coupling device provided on the car door. After the coupling, both the car door and the shaft door can be opened by the car door drive. This means that both the car door and the shaft door are opened/closed passively. This means that both the car door and the shaft door are opened/closed exclusively by means of the car door drive. This approach was mainly determined by the fact that there were no control electronics and no shaft door drive installed in shaft doors, which precluded active opening and/or closing of the shaft door. Attaching control electronics to each of the shaft doors and attaching shaft door drives to each of the shaft doors would have unduly increased the costs for the elevator system.

Due to the technological development of electronics and drives, in particular communication electronics, power electronics and electric motors, a cost-effective solution is made possible which can open and/or close both the car door and the shaft door by means of an active drive provided specifically for this purpose. Accordingly, a mechanically susceptible coupling, which transfers the opening movement caused by the car door drive to the shaft door, is no longer required. Nevertheless, it must be ensured in normal operation that both the car door and the shaft door can perform an opening movement only when the car door is arranged on the shaft door in order to ensure the safety of the elevator. Furthermore, it must be ensured that the car door and the shaft door are coordinated, that is to say, in particular, synchronously opened and/or closed.

### SUMMARY

It is therefore an object of the invention to provide an elevator system which enables a necessary degree of safety when the shaft door has a shaft door drive arranged on the shaft door itself.

The object is achieved by an elevator system with an elevator car which is movable in an elevator shaft, a car door arranged on the elevator car, a car door drive for closing and/or opening the car door, at least one shaft door arranged on a door opening of the elevator shaft, a shaft door drive for closing and/or opening the shaft door, a car door control unit, by means of which the car door drive can be directly controlled, a shaft door control unit, by means of which the shaft door drive can be directly controlled. The car door control unit and the shaft door control unit are connected to one another via a communication connection so that a synchronous opening and/or closing of the shaft door and the car door is made possible. In particular, the communication connection is designed to be wireless.

The invention is based on the finding that in an elevator system with a separate car door drive and shaft door drive, that is to say, in an elevator system in which no mechanical coupling exists between the two doors, it must be ensured that the shaft door and car door are opened and/or closed in a coordinated and, in particular, synchronized manner, that is to say, simultaneously and with the same driving curve. Since this way, the car door leaf and the shaft door leaf are opened and/or closed substantially synchronously. This is relevant, in particular, for the safety of the elevator system, since the opening of only one of the doors can lead to an unsafe state.

In the above and in the following, “directly” means the direct control of the drive by the corresponding control unit. “Directly” means that the electric machine is supplied with energy for the drives of the machine exclusively by the corresponding control unit. This means that the corresponding machine is influenced exclusively by the corresponding control unit in the rotation, that is to say, in particular started, stopped, decelerated and accelerated. However, it does not exclude that the control unit contains a type of enable signal from another control unit for controlling the corresponding drive. It also does not exclude that the corresponding control unit performs the control of the corresponding drive in coordination with another control unit.

In the above and in the following, a communication connection is a connection via which data in the form of commands, for example, in the form of binary numbers, can be transmitted.

In the above and in the following, “synchronous opening and/or closing” means that the shaft door and the car door are opened substantially identically, that is to say, the door leaves of the two doors each experience the same movement and thus the doors start opening at the same time, that is to say, leave their initial position and reach their respective end positions at the same time and are substantially at the point between the initial position and the end position during the entire movement between the initial position and the end position. “Synchronously” thus comprises the simultaneous starting of the opening as well as the synchronous, that is to say, the same, movement of the door leaves of the two doors during the opening process, thereby simultaneously reaching the end position.

The elevator system described above and in the following does not exclude an asynchronous or even individual opening and/or closing of the doors or of one of the doors in an operation deviating from normal operation, such as a maintenance operation, for example.

In a preferred embodiment of the elevator system, the shaft door control unit and/or car door control unit are designed such that they simultaneously control the shaft door and the car door after receiving an opening signal generated by the elevator system. The car door drive and the shaft door drive are operable for the opening process and/or the closing process at least such that the shaft door and the car door open and/or close synchronously.

It is thus made possible that the two independent door control units, that is to say, the car door control unit and the shaft door control unit, enable a coordinated opening and/or closing of the doors after receiving an opening signal. In the above and in the following, the opening signal is a signal which is generated by the elevator system and which can be equated with a command for opening and/or closing the doors. The shape of this signal is therefore insignificant, as long as it can be recognized that the elevator system is in a state in which it wishes to open the car door and shaft door. This opening signal can be the signal which moves the corresponding door control units to control the corresponding drive. However, the opening signal can also be a signal which is detected in the corresponding door control units and subsequently, for example, after processing further signals, for example, after checking the state of the door or checking the currently prevailing time by the corresponding door control unit, is converted to a control signal for the corresponding drive. The opening signal is generated by the elevator system, that is to say, by one of the components of the elevator system.

In a preferred embodiment, the shaft door drive and the car door drive each comprise a toothed belt for transmitting the torque of the drive to the shaft door or the car door. The shaft door drive or the car door drive are designed such that they both drive the corresponding door at a defined and substantially identical speed.

A synchronization of the opening and/or closing movement of the car door or shaft door is possible in a simple manner by means of a drive or drives designed in this way. With drives designed in this way, it is essentially only necessary to ensure that the initiation of the driving of the doors of both the shaft door control unit and in the car door control unit is started simultaneously. After receiving the drive command, the drives which are designed to be substantially identical and to operate with the substantially identical drive speed, open the respective door independently and without feedback about the other door movement, and, nevertheless, the design of the drives enables a simultaneous movement of the door leaves. This is facilitated, in particular, in that the torque of the respective drives is transmitted via a toothed belt to the corresponding door leaves. The use of a toothed belt instead of a flat belt makes it possible to ensure that no slip occurs and that the rotation of the drive is thus transmitted one to one to the respective door leaves. In such a system, it is therefore only necessary to ensure that the two drives start opening and/or closing at the same time and execute the drive operation substantially at the same speed.

It proves advantageous that no complex control loops are required in such a configuration of the elevator system. It is not necessary in this case, for example, for the shaft door control unit to know both the position of the shaft door and the position of the car door to control the shaft door more quickly or more slowly accordingly, in the event of a deviation of the positions. The accuracies required for this in terms of substantially identical drive speed and in terms of the substantially identical design of the shaft and car door can be achieved with today's manufacturing methods.

In a preferred embodiment of the elevator system, the shaft door control unit is designed for directly/indirectly sending the opening signal to the car door control unit. Alternatively, the car door control unit is designed for directly/indirectly sending the opening signal to the shaft door control unit.

In these two embodiments, a type of master-slave configuration is implemented in the local control units present in the doors. For example, in a first alternative, the shaft door control unit can be designed as a master. In this case, the shaft door control unit can be designed to send an opening signal to the car door control unit and to process the opening signal internally, that is to say, in the shaft door control unit, such that the opening signal results in a simultaneous start of the opening and/or closing movement of the car door control unit and the shaft door control unit. For example, both control units can have an internal clock. The shaft door control unit can send both the car door control unit and itself an opening command with a starting time (time specification). The starting time can, for example, be selected such that sufficient time remains that the car door control unit can receive and process this opening signal. In a further embodiment, the timing is to be so far in the future that the car door control unit cannot only receive the opening command, but also has sufficient time to return a termination command to the shaft door control unit.

Thus, a superordinate opening signal can be generated in the elevator system without an additional control unit. It is advantageous here that the effort of an additional, superordinate control unit is omitted and the elevator system can thus be designed more simply and more cost-effectively.

In one embodiment, the car door control unit is designed as the master.

In a further embodiment, the elevator system further comprises an elevator control unit, which is mounted, in particular, on the elevator car. In this embodiment, the communication connection between the shaft door control unit and the car door control unit is formed by two partial connections. The first partial connection is a wireless connection between the shaft door control unit and the elevator control unit. The second partial connection is a connection, preferably designed as a wireless connection, between the car door control unit and the elevator control unit.

In this embodiment, the master function can be implemented in the separate elevator control unit. The correspondingly executed connection between the local shaft door control unit and the local car door control unit to the elevator control unit makes it possible for the opening signal to be sent from the superordinate control unit to the two local control units. A method can thus be implemented, for example, in which the local control units, that is to say, the car door control unit and the shaft door control unit, determine a condition in which a secure opening of the respective doors is possible. The local control units communicate this determined state to the elevator control unit. After receiving these two pieces of information and, under certain circumstances, after checking further states of the elevator system, the elevator control unit can send the opening signal simultaneously, that is to say, to the two local control units in such a way, that there is a simultaneous opening and/or closing of the shaft door and car door. It is also advantageous here that the car door control unit and the shaft door control unit (that is to say, the local control units) can be substantially identical, i.e., the need for implementing a master-slave configuration in these control units is omitted.

In a preferred embodiment of the elevator system, the elevator system further comprises a shaft door sensor arranged on the shaft door, which shaft door sensor is directly connected to the shaft door control unit. Furthermore, the elevator system has a car door signal generator arranged on the car door. On the one hand, the shaft door sensor is arranged on the shaft door, and, on the other hand, the car door signal generator is arranged on the car door such that a car door signal of the car door generator can be received by the shaft door sensor when the car door is located in a door opening zone of the shaft door. The elevator system further has a car door sensor arranged on the car door, which car door sensor is directly connected to the car door control unit. The system also comprises a shaft door signal generator arranged on the shaft door. On the one hand, the car door sensor is arranged on the car door and, on the other hand, the shaft door signal generator on the shaft door such that the shaft door signal of the shaft door signal generator can be received by the car door sensor when the car door is located in a door opening zone of the shaft door. The elevator system is designed such that the opening signal can be generated by the car door sensor or the shaft door sensor after receiving the shaft door signal of the shaft door signal generator and the car door signal of the car door generator.

In this embodiment, both the shaft door control unit and the car door control unit have a signal generator sensor pair functionally associated with the control unit (in the case of the shaft door, a shaft door sensor and a car door signal generator, and in the case of the car door, a car door sensor and a shaft door signal generator), by means of which the presence of the respective other door in the vicinity of the corresponding control unit can be determined. It is thus made possible that the generation of the opening signal can be linked to the requirement of the presence of both a car door signal and a shaft door signal. In addition to the simultaneous and synchronous opening and/or closing of the car door and shaft door, a reliable or accident-preventing opening and/or closing of the two doors is thus also ensured. This makes it possible to further increase the safety of opening and/or closing the doors. Due to the presence of two such signal generator sensor pairs, a redundancy is formed in the elevator system, with which the safety of the elevator system can be further increased. Furthermore, the redundancy eliminates the need for these signal-emitting sensor pairs to be designed in a fail-safe manner, since the functionality of one of these pairs can be verified by the other pair.

In a preferred embodiment, the elevator system is designed such that the opening signal can be generated by the elevator control unit as soon as the elevator control unit has determined the reception of the shaft door signal by the car door sensor and/or the reception of the car door signal by the shaft door sensor. The elevator control unit is designed to subsequently transmit the opening signal to the car door control unit and to the shaft door control unit in such a way that a simultaneous opening and/or closing of the car door and the shaft door is made possible.

In this embodiment, the elevator control unit is used as a checking control unit which determines the presence of the corresponding signals of the car door sensor and of the shaft door sensor prior to transmitting the opening signal and thus ensures that the opening signal is only transmitted when both of these sensors determine the presence of the door to be detected by this sensor. As a result, it is made impossible in a simple manner that, in an unsafe state of the elevator system, the opening signal is transmitted to the executing control units, that is to say, the car door control unit and the shaft door control unit. This further increases the safety of the elevator system. In particular, it is thus made possible for an opening signal to be transmitted only if the connection between the shaft door control unit and the elevator control unit and the car door control unit and the elevator control unit is also functional. The functionality of this connection does not have to be ensured by a complicated regular check of the connections themselves, but is ensured by the presence of the superordinate elevator control unit and the condition that this control unit has to receive the signals of both local control units. This makes it possible that the connections can be designed in a simple manner, that is to say, for example, in a manner that is not fail-safe. This makes it possible to provide a secure and nevertheless simple and cost-effective elevator system.

In a preferred embodiment, the car door signal generator and/or the shaft door signal generator are designed as a magnetic signal generator comprising a magnet, in particular a permanent magnet. A magnet is a simple form of a signal generator. If the signal generator is designed as a magnet, the sensor, that is to say, the car door sensor and/or the shaft door sensor, is designed as a sensor for detecting a magnetic field. A permanent magnet is a purely mechanical component and therefore does not need any energy supply or the like. The use of a permanent magnet is therefore a simplest form of the signal generator. A signal generator and sensor pair can thus be implemented in a simple and cost-effective manner.

In a preferred embodiment, the elevator system further comprises an absolute positioning system, by means of which a position signal can be generated. The elevator system, in particular, the elevator control unit, is designed so that the opening signal can only be generated after the position signal has been verified.

The elevator system can be designed even more reliably by querying a position signal before generating the opening signal. The position signal can, for example, be a distance signal, i.e., a signal which reflects the current position of the elevator car in the elevator shaft. Thus, for example, the position signal at the lowest floor can have the smallest value, for example the value 0, and then increase continuously with the movement of the elevator car upward in the shaft, until the highest value is reached at the last floor. The verification of the position signal can be accomplished, for example, by matching a meter reading derived from the position signal with the detection of the shaft door signal of a specific shaft door control unit by the car door sensor. It can thus be provided, for example, that the elevator car executes a learning trip after installation, in which the elevator car is moved step by step in the shaft and couples itself to the corresponding shaft door signal generator at each floor by means of the car door sensor, and a position, that is to say, a distance from the lowest floor, is determined for each shaft door. This requires that the shaft door signals can be unambiguously associated with a specific shaft door, that is to say, that a specific shaft door signal differs from all other shaft door signals. For example, the shaft door signal generator on the lowest floor can have a weaker magnetic field than the signal generator of the shaft door on the second floor. These data (position signal with associated shaft door signal) can be stored after the learning trip, so that is possible to verify whether the position signal matches the shaft door signal detected by the car door sensor in future trips. It can thus be ensured that, for example, the car door sensor does not receive a different magnetic field anywhere between the floors, resulting in a transmission of an opening signal. It is thus made possible to make the door opening even more secure.

In a further embodiment of the elevator system, it further comprises a brake system for fixing the elevator car in the elevator shaft for a car hold. A locking signal can be generated by means of this brake system. The elevator system, in particular, the elevator controller, is designed so that the opening signal can only be generated after the verification of the locking signal.

The querying of the locking signal prior to generating the opening signal makes it possible to further increase the safety of opening and/or closing of the doors.

In a preferred embodiment, the shaft door drive and the car door drive preferably each comprise an encoder. The shaft door control unit and the car door control unit, and preferably the elevator control unit, are designed such that they form a closed-loop control for synchronously opening and/or closing the shaft door and the car door.

With the encoder, which is preferably present both on the car door and on the shaft door, the respective control unit can precisely determine the distance traveled by the respective door. By transmitting this determined path to the respective other control unit, it can subsequently be ensured that the two doors, that is to say, the car door and the shaft door, travel the same path in the same time and the movement of the two doors is thus synchronous. If one of the doors is already opened and/or closed more at a certain point in time, that is to say, it has covered a greater distance, the opening and/or closing movement of this door can be decelerated, while the opening and/or closing movement of the other door is continued at the same pace or is accelerated. This active control of the local control units can be designed in a type of master-slave configuration.

In another embodiment, this control can also be designed via the superordinate elevator control unit. In this embodiment, the local control units of the superordinate elevator control unit each share the position, that is to say, the encoder signal. The elevator control unit evaluates these signals and intervenes if necessary in a correcting manner.

The problem is also solved by a method for securely opening and/or closing a car door and a shaft door of an elevator system, in particular, an elevator system as described above and in the following. The method comprises the following steps:
generating a car door signal by means of a car door signal generator arranged on the car door;
receiving the car door signal by means of a shaft door sensor arranged on the shaft door;
transmitting the car door signal from the shaft door sensor to a shaft door control unit;
directly/indirectly transmitting the car door signal to a car door control unit by means of the shaft door control unit;
subsequently opening and/or closing the shaft door and the car door by directly controlling a shaft door drive through the shaft door control unit and by directly controlling a car door drive through the car door control unit.

With this method, simultaneous opening and/or closing of two independent doors, that is to say, mechanically non-coupled doors, that is to say, a shaft door and a car door, is made possible in a simple manner. This is made possible in a secure manner by checking the presence of both doors via the signal generator sensor pair, that is to say, the car door signal generator and the shaft door sensor. To carry out this check, the car door signal detected by the shaft door control unit via the shaft door sensor is transmitted from the shaft door control unit to the car door control unit. If the car door control unit has received this signal, both control units, that is to say, the shaft door control unit and the car door control unit, know that an opening and/or a closing of the doors can be carried out. Subsequently, the two door control units can, for example, start opening and/or closing the respective door by direct control at a time modulated onto the car door signal by the shaft door control unit. In such an embodiment of the method, the synchronization can be carried out without complex communication between the two control units. A comparatively simple and nevertheless safe method for simultaneously opening two independently driven doors of an elevator system is thus made available.

In a preferred embodiment of the method, the method further comprises, prior to the step of opening/closing, the steps:
generating a shaft door signal by means of a shaft door signal generator arranged on the shaft door;
receiving the shaft door signal by means of a car door sensor arranged on the car door;
transmitting the shaft door signal from the car door sensor to a car door control unit;
directly/indirectly transmitting the shaft door signal by means of the car door control unit to the shaft door control unit.

It has proven to be advantageous that a redundant determination of the presence of the respective other door is implemented with these additional method steps. Due to the fact that the respective sensor on both doors receives the respective signal (car door signal or shaft door signal) of the signal generator on the other door and the control unit transmits this signal to the respective other control unit via a connection, it can be ensured that even without the signal generator sensors being implemented in a fail-safe manner, the doors are only opened when the elevator system is in a safe state. A method can thus be implemented, which in the simplest manner enables a secure opening and/or closing of two non-coupled doors.

In a preferred embodiment of the method, as described above and in the following, the step of transmitting the car door signal and/or shaft door signal is carried out indirectly, wherein the car door signal and/or the shaft door signal is transmitted from the car door sensor or shaft door sensor to an elevator control unit, wherein an opening signal is subsequently generated by the elevator control unit and the opening signal is subsequently transmitted to the shaft door control unit and the car door control unit.

Such a method and the step of verifying the presence of both signals in the elevator control unit makes it possible to provide additional safety. It can thus be ensured that none of the two local control units, that is to say, the car door control unit or the shaft door control unit, begins to open the door after receiving the signal of the other control unit and after detection of the local signal by the corresponding sensor, without the other door also beginning with the opening. By transmitting the two signals to the elevator control unit and evaluating the presence of these two signals in elevator control unit, a sort of check of the connection of the local control units can be ensured without additional measures. After the elevator control unit received the two signals and checked the signals, the superordinate control unit must in turn send an opening signal back to the local control units. It can be assumed here that connections that are intact when the detected signals are transmitted from the local control units to the superordinate elevator control unit are still intact after the evaluation of these signals by the elevator control unit. Such an evaluation only takes a moment due to the simplicity of the signals, so that it is practically impossible or very unlikely that a connection which functions at the time of the transmission is no longer functioning after the evaluation. Thus, with this method, a safe method for opening and/or closing a car door and a shaft door of an elevator system can be made available in a simple manner without a fail-safe design of the connection, but by integrating a superordinate control unit.

### DESCRIPTION OF THE DRAWINGS

The invention is explained in more detail below with reference to embodiments in the FIGURES. In the FIGURES:

FIG. 1: shows an elevator system having a car which can travel in the elevator system; and

FIG. 2 shows a schematic illustration of the elevator system shown in FIG. 1.

### DETAILED DESCRIPTION

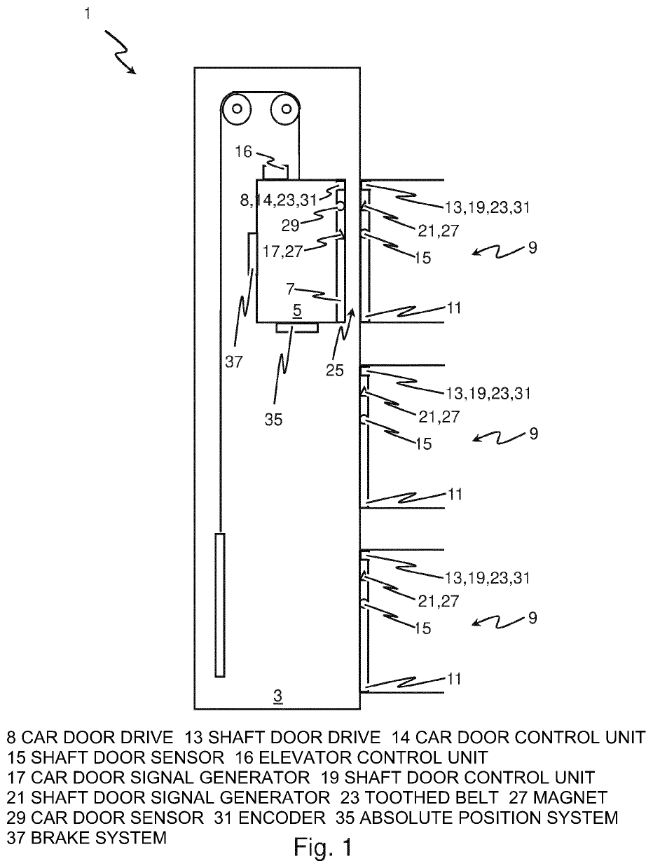

FIG. 1 shows an elevator system 1 typically arranged inside a building. The elevator system 1 comprises a car 5 which can travel in a usually vertically-oriented elevator shaft 3. A car door 7 is arranged on the car 5. The elevator shaft 3 has multiple door openings 9 arranged one above the other for enabling access to individual floors of the building. A shaft door 11 is arranged at each of these door openings 9. If the elevator car 5 and/or the car door 7 arranged on the elevator car 5 is positioned at one of these shaft doors 11, the elevator car 5 can be accessed from the building floor associated with the shaft door 11 when the car door 7 is open and the shaft door 11 is open.

The car door 7 has a car door drive 8 and a car door signal generator 17. Each of the shaft doors 11 has a shaft door drive 13. A shaft door control unit 19 is associated with each of these shaft door drives 13, and the shaft door control unit 19 can directly control the shaft door drive 13 associated with it. The shaft door 11 associated with the shaft door drive 13 can be unlocked and/or opened and closed by controlling the shaft door drive 13.

A shaft door sensor 15 is arranged on each of the shaft doors 11 such that the car door signal generated by the car door signal generator 17 can be received by the shaft door sensor 15—given a corresponding position of the elevator car 5 in the elevator shaft 3 at a door opening zone 25 of the shaft door 11. Accordingly, the shaft door sensor 15 of each of the shaft doors 11 is operatively connected to the shaft door control unit 19 of the same shaft door 11.

The car door signal generator 17, which is preferably designed as a magnet 27, in particular as a permanent magnet, causes a car door signal to be generated, which is subsequently receivable by the shaft door sensor 15 if the elevator car 5 is positioned at the shaft door 11 associated with the shaft door sensor 15. The shaft door sensor 15 is operatively connected to the shaft door control unit 19, so that the car door signal can be transmitted or is transmitted to the shaft door control unit 19.

The elevator system 1 further comprises a car door control unit 14, preferably fixed to the elevator car 5, and may comprise a car door sensor 29 arranged on the elevator car 5 or on the car door 7. A shaft door signal generated by a shaft door signal generator 21 can be received by the car door sensor 29. Such a shaft door signal generator 21 associated with the shaft door 11 is arranged on each shaft door 11. Each of the shaft door signal generators 21 generates a shaft door signal that is different from that from the other shaft door signal generators 21. The elevator car 5 further has an absolute position system 35 designed, for example, as a laser positioning system, and a brake system 37.

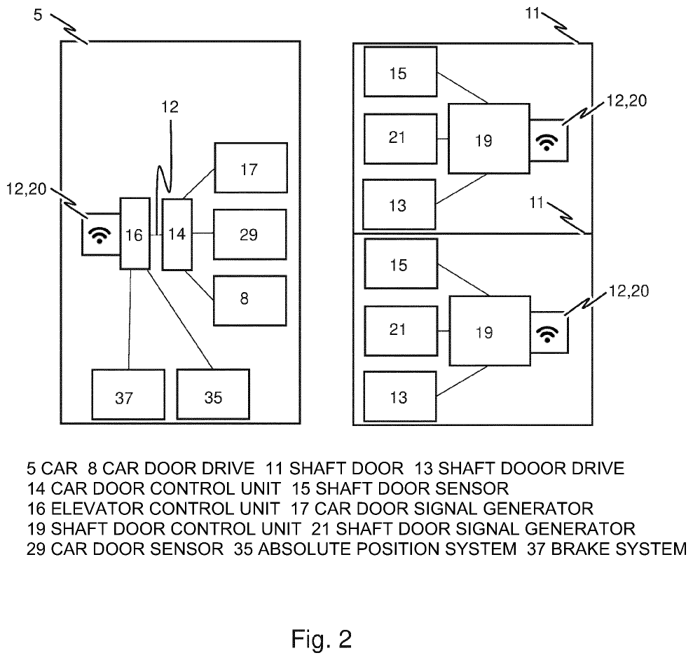

FIG. 2 shows a schematic illustration of the elevator system 1 shown in FIG. 1. The schematic illustration shows the shaft door control unit 19, the car door control unit 14 and the elevator control unit 16. In this exemplary embodiment, the car door control unit 14 and the elevator control unit 16 are both attached to the elevator car 5, wherein the communication connection 12 between these control units is designed as a wired connection in this exemplary embodiment. In this exemplary embodiment, the shaft door control units 19 and the car door control unit 14 are indirectly connected via a communication connection 12, which in this embodiment comprises the wired connection between the car door control unit 14 and the elevator control unit 16, and the wireless connection 20 between the elevator control unit 16 and the shaft door control unit 19. In addition, the absolute positioning system 35 and the brake system 37 for fixing the elevator car 5 are shown, wherein these systems are connected directly to the elevator control unit 16. The absolute position system 35 generates a position signal constantly or periodically. The position signal comprises the information as to at which location in the elevator shaft 3 the elevator car 5 is arranged, that is to say currently is. The brake system 37 comprising an arresting brake generates an arrest signal in the event that the car 5 is fixed in the elevator shaft 3. This means that the arrest signal is generated when the arresting brake blocks and consequently the elevator car 5 is no longer able to travel in the elevator shaft 3.

In this exemplary embodiment, a car door signal is generated by the car door sensor 29 after detection of the signal of the shaft door signal generator 21. The car door signal is transmitted to the elevator control 16 via the communication connection 12 designed as a wired connection. Likewise, a shaft door signal is generated by the shaft door sensor 15 after detection of the signal of the car door signal generator 17. The shaft door signal is transmitted to the elevator control 16 via the communication connection 12 designed as a wireless connection 20. The elevator controller 16 evaluates these two signals, as well as the position signal of the absolute position system 35 and the fixing signal of the brake system 37. If all the signal information matches, the elevator control unit 16 generates an opening signal, which the elevator control unit 16 transmits to the car door control unit 14 and the shaft door control unit 19 via the communication connection 12 in such a way that the latter simultaneously start opening the respective door by directly controlling the corresponding drive.

As explained above and shown in FIG. 1, the shaft door drive 13 and the car door drive 8 each comprise a toothed belt 23 for transmitting the torque of the drive to the shaft door 11 or the car door 7. The shaft door drive or the car door drive are designed such that they both drive the corresponding door at a defined and substantially identical speed. The shaft door drive 13 and the car door drive 8 preferably each comprise an encoder 31. The shaft door control unit 19 and the car door control unit 14, and preferably the elevator control unit 16, are designed such that they form a closed-loop control for synchronously opening and/or closing the shaft door and the car door. With the encoder 31, the respective control unit can precisely determine the distance traveled by the respective door. By transmitting this determined path to the respective other control unit, it can subsequently be ensured that the two doors, that is to say, the car door 7 and the shaft door 11, travel the same path in the same time and the movement of the two doors is thus synchronous.

In accordance with the provisions of the patent statutes, the present invention has been described in what is considered to represent its preferred embodiment. However, it should be noted that the invention can be practiced otherwise than as specifically illustrated and described without departing from its spirit or scope.

1.-14. (canceled)

15. An elevator system comprising:
an elevator car that travels in an elevator shaft of the elevator system;
a car door arranged on the elevator car;
a car door drive that closes and/or opens the car door;
a shaft door arranged on a door opening of the elevator shaft;
a shaft door drive that closes and/or opens the shaft door;
a car door control unit directly controlling the car door drive to close and/or open the car door;
a shaft door control unit directly controlling the shaft door drive to close and/or open the shaft door; and
wherein the car door control unit and the shaft door control unit are connected via a communication connection to synchronously close and/or open the shaft door and the car door.

16. The elevator system according to claim 15 wherein the car door control unit and the shaft door control unit are connected wirelessly.

17. The elevator system according to claim 15 wherein the shaft door control unit and/or car door control unit respond to receiving an opening signal generated by the elevator system to simultaneously control the shaft door drive and the car door drive to synchronously close and/or open the shaft door and the car door.

18. The elevator system according to claim 15 wherein the shaft door drive and the car door drive each include a toothed belt, the toothed belts transmitting torque of the shaft door drive to the shaft door and torque of the car door drive to the car door to drive the shaft door and the car door at a same defined speed.

19. The elevator system according to claim 15 wherein the shaft door control unit directly or indirectly sends an opening signal to the car door control unit, or the car door control unit directly or indirectly sends the opening signal to the shaft door control unit.

20. The elevator system according to claim 15 including an elevator control unit, wherein the communication connection is a first partial connection and a second partial connection between the shaft door control unit and the car door control unit, the first partial connection being a wireless connection between the shaft door control unit and the elevator control unit and the second partial connection being a wireless connection between the car door control unit and the elevator control unit.

21. The elevator system according to claim 20 wherein the elevator control unit is mounted on the elevator car.

22. The elevator system according to claim 15 including:
a shaft door sensor arranged on the shaft door, the shaft door sensor being directly connected to the shaft door control unit, and a car door signal generator arranged on the car door, wherein a car door signal generated by the car door generator is received by the shaft door sensor when the car door is in a door opening zone of the shaft door; and
a car door sensor arranged on the car door, the car door sensor being directly connected to the car door control unit, and a shaft door signal generator arranged on the shaft door, wherein a shaft door signal generated by the shaft door signal generator is received by the car door sensor when the car door is in a door opening zone of the shaft door.

23. The elevator system according to claim 22 wherein an opening signal is generated by the shaft door control unit to the car door control unit after the receipt of the shaft door signal by the car door sensor and the receipt of the car door signal by the shaft door sensor, or the opening signal is generated by the car door control unit to the shaft door control unit after the receipt of the shaft door signal by the car door sensor.

24. The elevator system according to claim 22 including an elevator control unit that generates an opening signal upon determining the receipt of the shaft door signal by the car door sensor and/or the receipt of the car door signal by the shaft door sensor, the elevator control unit transmitting the opening signal to the car door control unit and to the shaft door control unit to start simultaneous opening of the car door and the shaft door.

25. The elevator system according to claim 22 wherein the car door generator and/or the shaft door signal generator are a magnetic signal generator including a magnet.

26. The elevator system according to claim 25 wherein the magnet is a permanent magnet.

27. The elevator system according to claim 15 including an absolute position system that generates a position signal corresponding to a position of the elevator car in the elevator shaft, and an elevator control unit that generates an opening signal to the car door control unit and the shaft door control unit after verifying the position signal.

28. The elevator system according to claim 15 including a brake system adapted to fix the elevator car in the elevator shaft for a car hold and generate a locking signal, and an elevator control unit that generates an opening signal to the car door control unit and the shaft door control unit after verifying the locking signal.

29. The elevator system according to claim 15 wherein the shaft door drive and the car door drive each include an encoder, wherein the shaft door control unit, and the car door control unit and an elevator control unit form a closed-loop control for the synchronous opening and/or closing of the shaft door and the car door.

30. A method for opening and/or closing a car door and a shaft door of an elevator system, the method comprising the following steps:
generating a car door signal from a car door signal generator arranged on the car door;
receiving the car door signal by a shaft door sensor arranged on the shaft door;
transmitting the car door signal from the shaft door sensor to a shaft door control unit;
directly or indirectly transmitting the car door signal by the shaft door control unit to a car door control unit; and
subsequently simultaneously opening and/or closing the shaft door and the car door by directly controlling a shaft door drive of the shaft door through the shaft door control unit and by directly controlling a car door drive of the car door through the car door control unit.

31. The method according to claim 30 including performing, prior to the opening/closing step, further steps of:
generating a shaft door signal by a shaft door signal generator arranged on the shaft door;
receiving the shaft door signal by a car door sensor arranged on the car door;
transmitting the shaft door signal from the car door sensor to the car door control unit; and
directly or indirectly transmitting the shaft door signal by the car door control unit to the shaft door control unit.

32. The method according claim 31 wherein the step of transmitting the car door signal and/or the step of transmitting the shaft door signal is indirectly carried out, wherein the car door signal and/or the shaft door signal are transmitted from the car door sensor or the shaft door sensor respectively to an elevator control unit, and wherein the elevator control unit subsequently generates an opening signal and transmits the opening signal to the shaft door control unit and to the car door control unit.
